(19) United States
(12) Patent Application Publication
(10) Pub. No.: US 2024/0271529 A1
(43) Pub. Date: Aug. 15, 2024

(54) RADIAL TURBINE IMPELLER

(71) Applicant: HONDA MOTOR CO., LTD., Tokyo (JP)

(72) Inventor: Yuta TAKEUCHI, Saitama (JP)

(21) Appl. No.: 18/531,953

(22) Filed: Dec. 7, 2023

(30) Foreign Application Priority Data
Feb. 9, 2023 (JP) 2023-018248

(51) Int. Cl. F01D 5/04; F01D 5/14

(52) U.S. Cl. CPC F01D 5/04; F01D 5/141; F05D 2220/32; F05D 2240/24; F05D 2240/30

(57) ABSTRACT

A radial turbine impeller includes a hub having a substantially conical shape and multiple turbine blades provided on an outer peripheral surface of the hub at intervals in a rotational direction. The turbine blades include full blades and splitter blades arranged alternately in the rotational direction of the radial turbine impeller, the splitter blades having a shorter blade length in a fluid flow direction in the radial turbine impeller than the full blades. Each splitter blade has a part deviated in a direction opposite to the rotational direction from a midpoint of an interval in the rotational direction between adjacent ones of the full blades.

### TECHNICAL FIELD

The present invention relates to a radial turbine impeller.

### BACKGROUND ART

In a radial turbine used in a turbine machine, which typically is a gas turbine engine, a compressed fluid, such as a compressed high-temperature gas, is supplied to a turbine impeller from a turbine nozzle defined by stator blades (vanes). The compressed fluid expands in volume and the flow velocity thereof increases when passing the turbine nozzle, whereby the compressed fluid supplied to the turbine impeller rotates the turbine impeller at a high speed.

To rotate the turbine impeller at a higher speed, it is necessary not only to increase the expansion ratio of the turbine but also to make the compressed fluid flow between the turbine blades of the turbine impeller at a higher flow rate.

However, as the flow rate of the compressed fluid flowing between the turbine blades increases, the difference between the pressures acting on the positive pressure surface (pressure side) and the negative pressure surface of each turbine blade increases, and this can lead to lowering of the adiabatic efficiency of the turbine. Also, in the turbine, there is a demand to increase the adiabatic efficiency of the turbine over a wide range of flow rate (expansion ratio) of the compressed fluid.

Note that in a single turbine blade, the positive pressure surface is a blade surface positioned on the side opposite to the rotational direction of the turbine impeller (the delay side in the rotational direction), and the negative pressure surface is a blade surface positioned in the rotational direction of the turbine impeller (the advance side in the rotational direction).

As a turbine impeller which solves the above problems and satisfies the above demands, there is proposed a turbine impeller in which two types of blades, namely, full blades which have a long blade length and splitter blades which have a short blade length, are arranged alternately in the rotational direction of the turbine impeller (see JP2011-117344A, JP2017-193984A, and JP2017-193985A, for example).

As shown in (B) of FIG. 4, in the conventional radial turbine impeller, a splitter blade 110 is disposed between two full blades 100 adjacent to each other in the rotational direction such that the splitter blade 110 extends from a midpoint N of the interval in the rotational direction between the full blades 100 on the fluid inlet side (a side where the compressed fluid flows into the radial turbine impeller) toward the fluid outlet side. When the flow path defined between the positive pressure surface 112 of the splitter blade 110 and the negative pressure surface 104 of one of the full blades 100 is referred to as a flow path A and the flow path defined between the negative pressure surface 114 of the splitter blade 110 and the positive pressure surface 102 of another of the full blades 100 is referred to as a flow path B, the flow path length Fa from the inlet Ain of the flow path A to the throat S of the full blades 100 and the flow path length Fb from the inlet Bin of the flow path B (the same position as the inlet Ain as seen in the fluid flow direction) to the throat S of the full blades 100 are different from each other.

Therefore, a difference occurs in the adiabatic efficiency of the turbine between the two flow paths A and B. Specifically, since the flow path length Fa is shorter than the flow path length Fb, the adiabatic efficiency of the turbine due to the compressed fluid flowing in the flow path A on the side of the positive pressure surface 112 of the splitter blade 110 is lower than the adiabatic efficiency of the turbine due to the compressed fluid flowing in the flow path B on the side of the negative pressure surface 114 of the splitter blade 110. This can hinder improvement of the overall efficiency of the turbine.

### SUMMARY OF THE INVENTION

In view of the foregoing background, a primary object of the present invention is to provide a radial turbine impeller in which the full blades and the splitter blades are arranged alternately in the rotational direction of the turbine impeller, such that factors hindering the improvement of the adiabatic efficiency of the turbine are reduced, whereby the adiabatic efficiency of the turbine is improved.

To achieve the above object, one aspect of the present invention provides a radial turbine impeller (58) comprising a hub (70) having a substantially conical shape and multiple turbine blades provided on an outer peripheral surface (70A) of the hub at intervals in a rotational direction, wherein the turbine blades include full blades (80) and splitter blades (90) arranged alternately in the rotational direction of the radial turbine impeller, the splitter blades having a shorter blade length in a fluid flow direction (F) in the radial turbine impeller than the full blades, and each splitter blade has a part deviated in a direction opposite to the rotational direction from a midpoint (N) of an interval in the rotational direction between adjacent ones of the full blades.

According to this aspect, factors hindering the improvement of the adiabatic efficiency of the turbine are reduced, and the efficiency of the radial turbine is improved.

Preferably, provided that a surface of each of the full blades and the splitter blades on which a fluid pressure acts in the rotational direction is referred to as a positive pressure surface (82, 92) and a surface of each of the full blades and the splitter blades opposite from the positive pressure surface is referred to as a negative pressure surface (84, 94), each splitter blade includes a part deviated toward the negative pressure surface of the full blade that is adjacent to the splitter blade in the direction opposite to the rotational direction.

According to this aspect, the load on the positive pressure surface and the load on the negative pressure surface of each full blade are made even, and the adiabatic efficiency of the turbine is improved.

Preferably, a first flow path (C1) is defined between the positive pressure surface of each splitter blade and the negative pressure surface of the full blade adjacent to the splitter blade in the direction opposite to the rotational direction, and a second flow path (C2) is defined between the negative pressure surface of each splitter blade and the positive pressure surface of the full blade adjacent to the splitter blade in the rotational direction, and a width of the first flow path in the rotational direction is smaller than a width of the second flow path in the rotational direction.

According to this aspect, the load on the positive pressure surface and the load on the negative pressure surface of each full blade are made even, and the adiabatic efficiency of the turbine is improved.

Preferably, a ratio of the width of the first flow path in the rotational direction to the width of the second flow path in the rotational direction is greater than or equal to 0.7 and less than 1.0.

According to this aspect, the adiabatic efficiency of the turbine is effectively improved.

Preferably, an entirety of each splitter blade is deviated in the direction opposite to the rotational direction from the midpoint of the interval in the rotational direction between the adjacent ones of the full blades.

According to this aspect, the load on the positive pressure surface and the load on the negative pressure surface of each full blade are made even, and the adiabatic efficiency of the turbine is improved.

Preferably, a part of each splitter blade on a side of a tip edge which is remote from the outer peripheral surface of the hub is more deviated toward the negative pressure surface of the full blade that is adjacent to the splitter blade in the direction opposite to the rotational direction than a part of the splitter blade on a side of a base edge which is joined to the outer peripheral surface of the hub.

According to this aspect, the adiabatic efficiency of the turbine is improved, and in addition, even with a large number of turbine blades, the manufacturability of the impeller is prevented from being lowered.

According to the foregoing aspect, factors hindering the improvement of the adiabatic efficiency of the turbine are reduced, and the adiabatic efficiency of the radial turbine is improved.

### BRIEF DESCRIPTION OF THE DRAWINGS

FIG. 1 is a sectional view of a gas turbine system for power generation provided with a radial turbine impeller;

FIG. 2 is a perspective view of a radial turbine impeller according to the first embodiment;

FIG. 3 is a meridian cross-sectional view of the radial turbine impeller according to the first embodiment;

FIG. 4 includes part (A) which is a sectional view of turbine blades of the radial turbine impeller according to the first embodiment taken along a plane connecting the positions whose height has the same ratio to the blade height, and part (B) which is a sectional view similar to part (A) and shows turbine blades of a conventional radial turbine impeller;

FIG. 5 is a graph showing the adiabatic efficiency-expansion ratio characteristics of the radial turbine; and

FIG. 6 is a turbine blade row diagram of a radial turbine impeller according to the second embodiment.

### DETAILED DESCRIPTION OF THE INVENTION

In the following, embodiments of the present invention will be described with reference to the drawings.

### First Embodiment

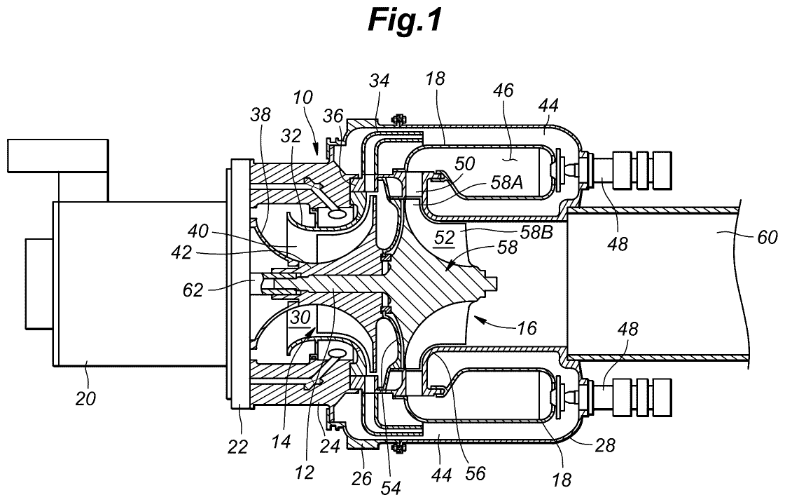

A first embodiment of the present invention will be described with reference to FIGS. 1 to 4. FIG. 1 is a sectional view of a gas turbine system 10 for power generation provided with a radial turbine impeller 58 according to the first embodiment. As shown in FIG. 1, the gas turbine system 10 for power generation includes a radial compressor 14 and a radial turbine 16 which are coaxially connected to each other by a rotation shaft 12, combustors 18, and an electric generator 20 connected to the rotation shaft 12.

The gas turbine system 10 for power generation includes a front end plate 22, a front housing 24, an intermediate housing 26, and a rear housing 28 which are connected to each other in the axial direction in order.

The radial compressor 14 includes a compressor housing 32 mounted to the front housing 24 and defining a compressor chamber 30, a diffuser fixing member 36 mounted to the front housing 24 and fixing a diffuser 34, and an air intake guide member 38 mounted to the front end plate 22. The air intake guide member 38 cooperates with the compressor housing 32 to define an air intake 40. In the compressor chamber 30, a compressor impeller 42 mounted on the rotation shaft 12 is rotatably disposed. The compressor impeller 42 is rotationally driven by the rotation shaft 12 which is an output shaft of the radial turbine 16. On the diffuser fixing member 36, the diffuser 34 is mounted.

The radial compressor 14 takes in air (outside air) through the air intake 40, compresses and pressurizes the air by the rotation of the compressor impeller 42, and supplies the compressed and pressurized air (compressed air) to the diffuser 34.

In the rear housing 28, the combustors 18 are provided around the central axis of the rotation shaft 12. The rear housing 28 includes parts that define compressed air passages 44 for guiding the compressed air from the diffuser 34 to the respective combustors 18. Each combustor 18 defines a combustion chamber 46. Each combustor 18 has a fuel injection nozzle 48 mounted thereon. The fuel injection nozzle 48 injects fuel into the combustion chamber 46.

In each combustion chamber 46, the mixture of the fuel injected into the combustion chamber 46 by the fuel injection nozzle 48 and the compressed air from the radial compressor 14 combusts, and a high-pressure combustion gas (compressed fluid) is generated. A turbine nozzle 50 of the radial turbine 16 is provided at gas outlets of the combustors 18.

The radial turbine 16 includes a turbine chamber 52 defined by an inner part of the rear housing 28 and communicating with the gas outlet of each combustor 18. The turbine chamber 52 is separated from the compressor chamber 30 by a partition wall member 54. A side of the turbine chamber 52 opposite from the partition wall member 54 is defined by a shroud 56. In the turbine chamber 52, the radial turbine impeller 58 integrally including the rotation shaft 12 is rotatably disposed.

The turbine nozzle 50 has a circular annular shape so as to surround the radial turbine impeller 58, and ejects the combustion gas radially inward and circumferentially toward the radial turbine impeller 58. The radial turbine impeller 58 is rotationally driven by the combustion gas ejected from the turbine nozzle 50. The combustion gas that has rotationally driven the radial turbine impeller 58 is discharged from an exhaust gas passage 60 to the atmosphere as an exhaust gas.

The rotation shaft 12 is connected to a rotor shaft 62 of the electric generator 20. Thereby, the electric generator 20 is rotationally driven by the rotation shaft 12 of the radial turbine 16 and generates electricity.

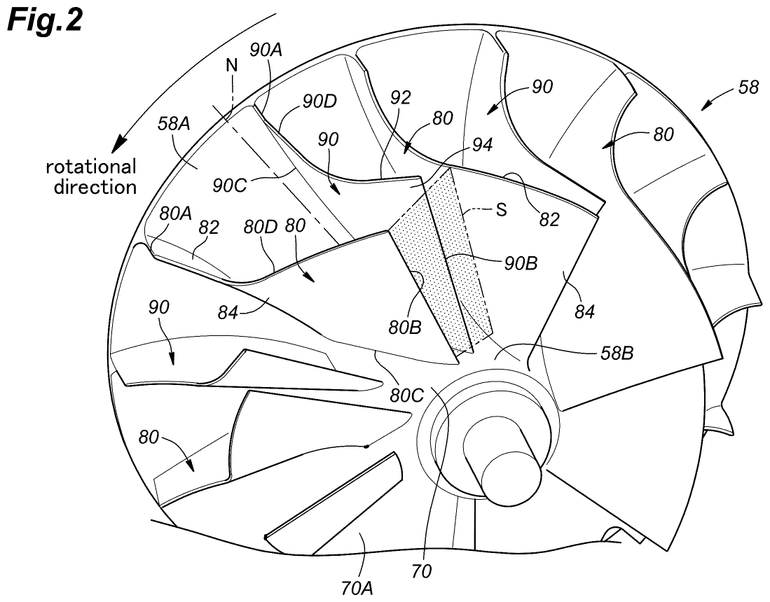

Next, details of the radial turbine impeller 58 will be described with reference to FIGS. 2 to 4.

The radial turbine impeller 58 (may be simply referred to as the turbine impeller 58 in the following description) includes a hub 70 having a substantially conical shape, and multiple full blades 80 and splitter blades 90 provided on an outer peripheral surface 70A of the hub 70 at intervals in the rotational direction of the turbine impeller 58. In the following description, the full blades 80 and the splitter blades 90 may be collectively referred to as the turbine blades.

The full blades 80 and the splitter blades 90 are disposed alternately in the rotational direction of the turbine impeller 58.

The rotational direction of the turbine impeller 58 is a counterclockwise direction in FIG. 2. In the following description, the rotational direction of the turbine impeller 58 may be simply referred to as the rotational direction.

Each full blade 80 extends over the substantially entire length of the outer peripheral surface 70A of the hub 70 in the generatrix direction, namely, extends from a fluid inlet end 58A to a fluid outlet end 58B of the turbine impeller 58.

The fluid inlet end 58A of the turbine impeller 58 is located in a position corresponding to the turbine nozzle 50 (see FIG. 1). The fluid outlet end 58B of the turbine impeller 58 is located in a position corresponding to the exhaust gas passage 60 (see FIG. 1).

Each full blade 80 has a leading edge 80A positioned in the fluid inlet end 58A, a trailing edge 80B positioned in the fluid outlet end 58B, a base edge (root edge) 80C joined to the outer peripheral surface 70A of the hub 70 and extending along the outer peripheral surface 70A between the leading edge 80A and the trailing edge 80B, and a tip edge 80D which is remote from the outer peripheral surface 70A of the hub 70 and extends along the inner peripheral surface of the shroud 56 (see FIG. 1) between the leading edge 80A and the trailing edge 80B.

Each splitter blade 90 has a leading edge 90A positioned at the fluid inlet end 58A of the turbine impeller 58, a trailing edge 90B positioned at the fluid outlet end 58B of the turbine impeller 58, a base edge (root edge) 90C joined to the outer peripheral surface 70A of the hub 70 and extending along the outer peripheral surface 70A between the leading edge 90A and the trailing edge 90B, and a tip edge 90D which is remote from the outer peripheral surface 70A of the hub 70 and extends along the inner peripheral surface of the shroud 56 (see FIG. 1) between the leading edge 90A and the trailing edge 90B.

Here, the surface of each full blade 80 and each splitter blade 90 on which the fluid pressure acts in the rotational direction is referred to as a positive pressure surface 82, 92, and the surface opposite from the positive pressure surface 82, 92 is referred to as a negative pressure surface 84, 94.

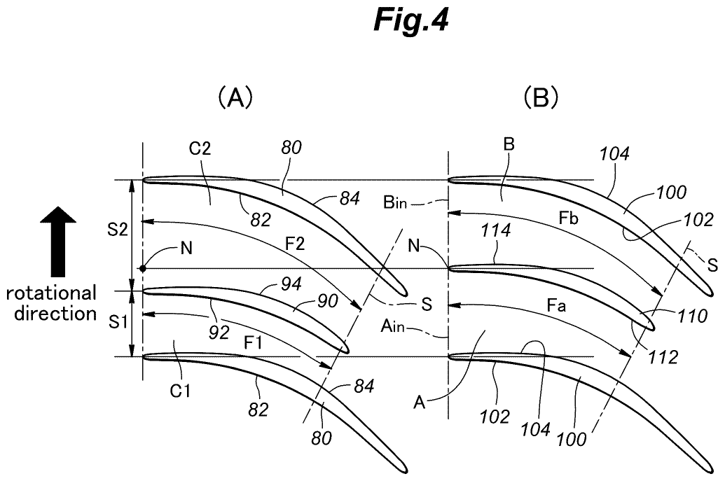

As shown in part (A) of FIG. 4, each splitter blade 90 and the full blade 80 adjacent to the splitter blade 90 in the direction opposite to the rotational direction define a first flow path C1 between the positive pressure surface 92 of the splitter blade 90 and the negative pressure surface 84 of the full blade 80, and each splitter blade 90 and the full blade 80 adjacent to the splitter blade 90 in the rotational direction define a second flow path C2 between the negative pressure surface 94 of the splitter blade 90 and the positive pressure surface 82 of the full blade 80.

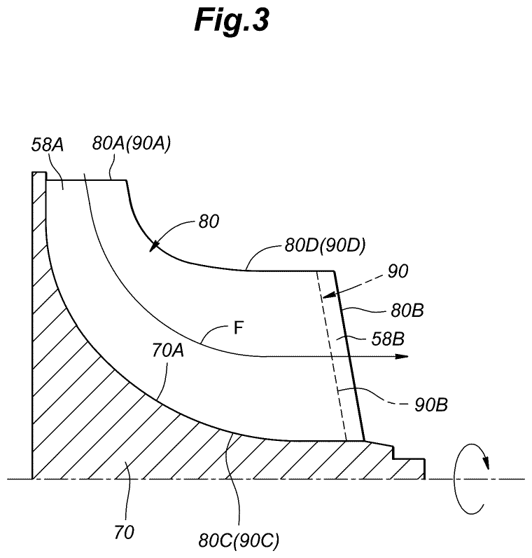

The leading edge 80A of each full blade 80 and the leading edge 90A of each splitter blade 90 are positioned at the fluid inlet end 58A with respect to a fluid flow direction F (see FIG. 3) in the turbine impeller 58. The trailing edge 90B of each splitter blade 90 is positioned on an upstream side of the trailing edge 80B of each full blade 80 with respect to the fluid flow direction F. As a result, the blade length of each splitter blade 90 is shorter than the blade length of each full blade 80 in the fluid flow direction F.

As shown in part (A) of FIG. 4, the flow path length F1 of the first flow path C1 from the fluid inlet end 58A to the throat S of the full blades 80 is shorter than the flow path length F2 of the second flow path C2 from the fluid inlet end 58A to the throat S of the full blades 80.

The entire part of each splitter blade 90 from the base edge 90C to the tip edge 90D is deviated in a direction opposite to the rotational direction, namely, toward the delay side in the rotational direction of the turbine impeller 58, from a midpoint N of the interval in the rotational direction between the adjacent ones of the full blades 80. In other words, the entirety of each splitter blade 90 is deviated toward the negative pressure surface 84 of the full blade 80 from the midpoint N.

Due to this deviation, as shown in (A) of FIG. 4, the width S1 of the first flow path C1 in the rotational direction is smaller than the width S2 of the second flow path C2 in the rotational direction. Since the width S2 is greater than the width S1, the flow rate of the combustion gas flowing through the second flow path C2 increases compared to when the splitter blade 90 is in the midpoint N, and the flow rate of the combustion gas flowing through the first flow path C1 decreases compared to when the splitter blade 90 is in the midpoint N. Note that in part (A) of FIG. 4, the widths S1, S2 represent the widths of the first flow path C1 and the second flow path C2 at the fluid inlet end 58A, but the relationship that the width S2 is greater than the width S1 holds over the entire lengths of the first flow path C1 and the second flow path C2.

Since the width S2 is greater than the width S1, the flow rate of the combustion gas flowing through the second flow path C2 which has the flow path length F2 longer than the flow path length F1 increases compared to the flow rate of the combustion gas flowing through the first flow path C1 which has the flow path length F1 shorter than the flow path length F2.

Therefore, the load (pressure) on the positive pressure surface 82 and the load (pressure) on the negative pressure surface 84 of each full blade 80 are made even, and the adiabatic efficiency of the radial turbine 16 is improved.

To obtain the above effect reliably and noticeably, the ratio of the width S1 of the first flow path C1 to the width S2 of the second flow path C2 (S1/S2) preferably is greater than or equal to 0.7 and less than 1.0.

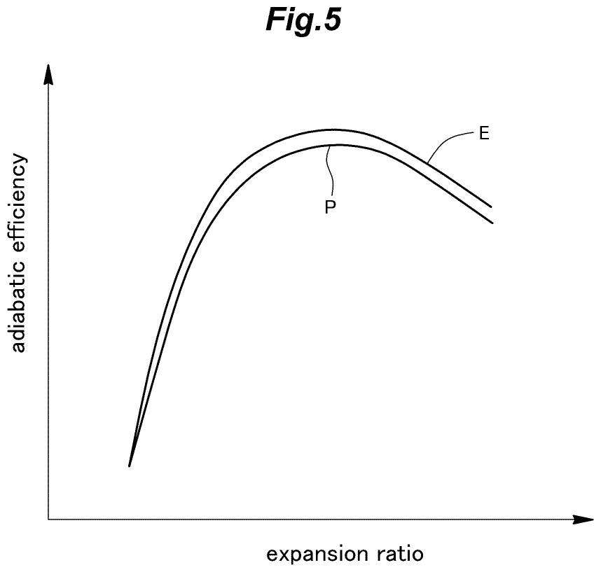

FIG. 5 shows the adiabatic efficiency-expansion ratio characteristics of the radial turbine 16 of the embodiment in which S1/S2=0.8 and of a conventional example in which S1/S2=1.0. In FIG. 5, a characteristics curve E represents the adiabatic efficiency characteristics when S1/S2=0.8, and a characteristics curve P represents the adiabatic efficiency characteristics when S1/S2=1.0.

From the comparison between the characteristics curve E and the characteristics curve P, it can be seen that when S1/S2=0.8, the adiabatic efficiency is improved over a wide range of expansion ratio compared to when S1/S2=1.0.

### Second Embodiment

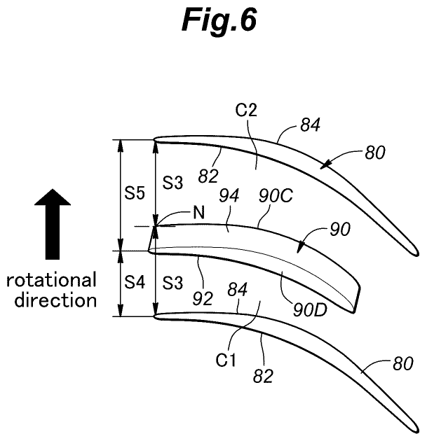

Next, details of the radial turbine impeller 58 according to the second embodiment will be described with reference to FIG. 6. Note that in FIG. 6, parts corresponding to those shown in FIGS. 1 to 4 are denoted by the same reference signs as in FIGS. 1 to 4, and the description thereof will be omitted.

In each splitter blade 90, a part on the side of the tip edge 90D (see FIGS. 2 and 3) which is remote from the outer peripheral surface 70A of the hub 70 (see FIG. 3) is deviated toward the negative pressure surface 84 of the full blade 80, namely, toward the delay side in the rotational direction, compared to a part on the side of the base edge 90C which is joined to the outer peripheral surface 70A of the hub 70. In other words, each splitter blade 90 includes the base edge 90C positioned at the midpoint N of the interval in the rotational direction between the adjacent ones of the full blades 80, and the splitter blade 90 is more deviated toward the delay side in the rotational direction as it extends from the base edge 90C to the tip edge 90D.

At the fluid inlet end 58A (see FIG. 3), the first flow path C1 and the second flow path C2 have the same width S3 in the rotational direction at the base edge 90C. The width of the first flow path C1 in the rotational direction progressively decreases from the base edge 90C toward the tip edge 90D, while the width of the second flow path C2 in the rotational direction progressively increases from the base edge 90C toward the tip edge 90D. As a result, at the fluid inlet end 58A, a width S4 of the first flow path C1 at the tip edge 90D becomes smaller than the width S3, and a width S5 of the second flow path C2 at the tip edge 90D becomes greater than the width S3.

Thereby, on the side of the tip edges 80D, 90D of the full blades 80 and the splitter blades 90, the flow rate in the first flow path C1 becomes smaller than the flow rate in the second flow path C2, whereby the adiabatic efficiency on the side of the tip edges 80D, 90D improves. In addition, the adiabatic efficiency of the radial turbine 16 on the side of the base edges 80C, 90C is maintained, and thus, the adiabatic efficiency of the radial turbine 16 as a whole improves.

In this embodiment, though the width S4 of the first flow path C1 on the side of the tip edges 80D, 90D is reduced as a result of enlarging the width S5 of the second flow path C2 on the side of the tip edges 80D, 90D, the first flow path C1 and the second flow path C2 have the same width S3 on the side of the base edges 80C, 90C. Therefore, a sufficient blade spacing can be ensured between the full blades 80 and the splitter blades 90.

Thus, the widths of the first and second flow paths C1, C2 on the tip edge side are adjusted to adjust the flow rates in the first and second flow paths C1, C2, while a sufficient blade spacing is ensured. Therefore, the fillets of the full blades 80 and the splitter blades 90 can be formed easily on the hub 70 with sufficient thicknesses, without interference between the processing tool and the blades.

Also, even in the case where the turbine impeller 58 is provided with many blades and hence the blade spacing is relatively small, the flow rates in the flow paths defined between the blades can be adjusted without further reducing the blade spacing on the base edge side, and therefore, the manufacturability of the turbine impeller 58 is not lowered. Moreover, it is not necessary to reduce the thicknesses of the full blades 80 and the splitter blades 90 for the manufacturability of the turbine impeller 58, and thus, excellent durability and high reliability can be achieved.

Concrete embodiments of the present invention have been described in the foregoing, but the present invention is not limited to the above embodiments and may be modified or altered in various ways. For example, the shape of the hub 70 and the number of full blades 80 and splitter blades 90 may be changed as appropriate. The radial turbine impeller 58 of the present embodiment is not limited to the impeller of the radial turbine 16 of the gas turbine system 10 for power generation, and may be used as an impeller of any of various radial turbines.

1. A radial turbine impeller comprising a hub having a substantially conical shape and multiple turbine blades provided on an outer peripheral surface of the hub at intervals in a rotational direction,
wherein the turbine blades include full blades and splitter blades arranged alternately in the rotational direction of the radial turbine impeller, the splitter blades having a shorter blade length in a fluid flow direction in the radial turbine impeller than the full blades, and
each splitter blade has a part deviated in a direction opposite to the rotational direction from a midpoint of an interval in the rotational direction between adjacent ones of the full blades.

2. The radial turbine impeller according to claim 1, wherein provided that a surface of each of the full blades and the splitter blades on which a fluid pressure acts in the rotational direction is referred to as a positive pressure surface and a surface of each of the full blades and the splitter blades opposite from the positive pressure surface is referred to as a negative pressure surface, each splitter blade includes a part deviated toward the negative pressure surface of the full blade that is adjacent to the splitter blade in the direction opposite to the rotational direction.

3. The radial turbine impeller according to claim 2, wherein a first flow path is defined between the positive pressure surface of each splitter blade and the negative pressure surface of the full blade adjacent to the splitter blade in the direction opposite to the rotational direction, and a second flow path is defined between the negative pressure surface of each splitter blade and the positive pressure surface of the full blade adjacent to the splitter blade in the rotational direction, and
a width of the first flow path in the rotational direction is smaller than a width of the second flow path in the rotational direction.

4. The radial turbine impeller according to claim 3, wherein a ratio of the width of the first flow path in the rotational direction to the width of the second flow path in the rotational direction is greater than or equal to 0.7 and less than 1.0.

5. The radial turbine impeller according to claim 1, wherein an entirety of each splitter blade is deviated in the direction opposite to the rotational direction from the midpoint of the interval in the rotational direction between the adjacent ones of the full blades.

6. The radial turbine impeller according to claim 2, wherein a part of each splitter blade on a side of a tip edge which is remote from the outer peripheral surface of the hub is more deviated toward the negative pressure surface of the full blade that is adjacent to the splitter blade in the direction opposite to the rotational direction than a part of the splitter blade on a side of a base edge which is joined to the outer peripheral surface of the hub.
